(19) United States
(12) Patent Application Publication
(10) Pub. No.: US 2025/0222629 A1
(43) Pub. Date: Jul. 10, 2025

(54) METHOD AND ARRANGEMENT FOR EXTRUDING RECYCLED MATERIAL

(71) Applicant: Johannes Wissing, Stadtlohn (DE)

(72) Inventor: Johannes Wissing, Stadtlohn (DE)

(21) Appl. No.: 18/850,690

(22) PCT Filed: Mar. 23, 2023
(86) PCT No.: PCT/EP2023/057538

§ 371 Date: Dec. 16, 2024

(30) Foreign Application Priority Data
Mar. 25, 2022 (DE) 10 2022 107 060.3

(51) Int. Cl. B29B 17/04; B29B 7/42; B29B 9/06; B29B 9/08; B29B 17/00

(52) U.S. Cl. CPC B29B 17/0412; B29B 7/42; B29B 9/065; B29B 9/08; B29B 17/0036

(57) ABSTRACT

The invention relates to a method for extruding recyclate, wherein the recyclate contains light materials and/or fibres and wherein the recyclate is first comminuted and compacted and, in a subsequent method step, is fed into an extruder (2). According to the invention, the recyclate is agglomerated in a press agglomerator and in the process is heated, and is divided into pellets, and, when still in the warm state, is fed into the extruder (2) with the material still having an inherent residual temperature of at least 50° C. from the agglomeration. The invention also relates to an arrangement (1) comprising an extruder (2) which has an inlet for the material to be extruded, and a press agglomerator which has an inlet opening (6) for recyclate to be agglomerated and an outlet for the pellets produced, wherein the press agglomerator is arranged upstream of the extruder (2) such that the inlet of the extruder (2) is connected to the outlet of the press agglomerator.

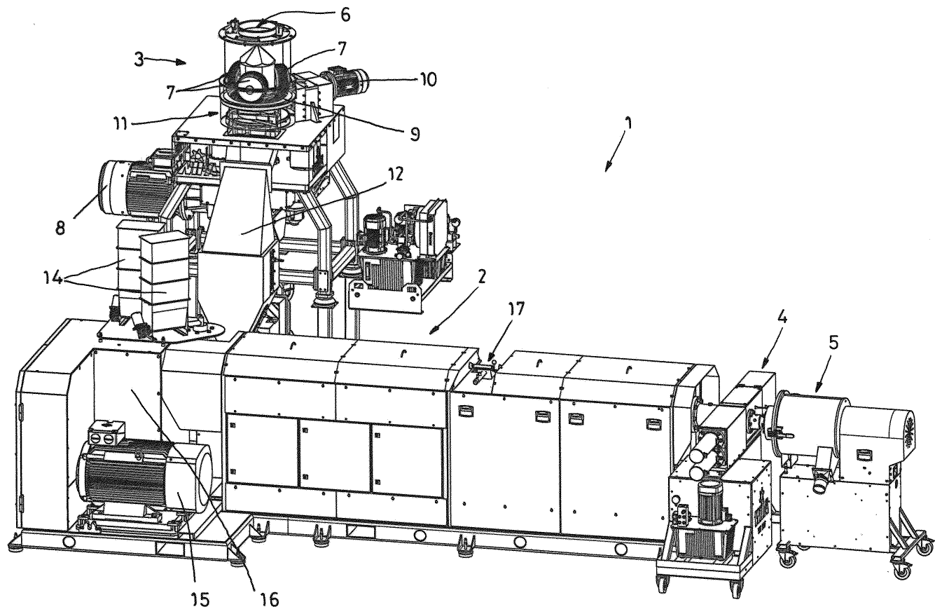

The invention relates to a method for extruding recycled material, what is referred to as recyclate, and to an arrangement for carrying out the method. The recyclate in question is in particular plastics materials. The recyclate can contain, among other things, foils and fibrous constituents, e.g. also plant fibers.

A method of the type in question is known from practice.

For example, it is known that the intake behavior of an extruder screw, which is used to guide the recyclate to be extruded up to the extruder, can be problematic. In particular in the case of light substances and fibers, it has time and again proven to be difficult to load the extruder screw with the recyclate. The fact that air pockets emerge in the extruder is unavoidable but undesirable. Air pockets can in the fully extruded material either result in bubbles, that is to say in cavities in the material, or at least in an interruption of the homogeneity of the material, for example when two regions lie against one another in each case with a “skin”, with the result that later on, in a component, at this location there is no cavity, but for example the ability of the material to bear mechanical loads is considerably reduced-similarly to how it is with a notch effect.

To counteract this, efforts can be made to provide negative-pressure regions in the extruder, in order to thereby eliminate bubbles. This is done in particular in the case of air pockets that extend up to the outer side of the flow of material in the extruder or come very close to the outer side of the flow of material, such that the outer skin of the flow of material tears open and the air can escape. However, air pockets that are deeper inside the material cannot be removed from the material in this way.

As a further measure of avoiding air pockets as far as possible, efforts can be made to as far as possible completely fill the screw channels of the extruder screw with material, in order in this way to as far as possible avoid gaps or bubbles in the material already when the extruder screw is being loaded and also in the further course of the process, in which the material is conveyed through the extruder. In order to as far as possible avoid cavities from the start, it is therefore known practice to stuff the extruder screw. In the process, the prepared particulate or fibrous material is conveyed with a feed screw into the intake of the extruder screw. A cross-sectional tapering in the conveying direction of the feed screw, e.g. a conical reduction in cross section, causes the fed material to be compacted before it enters the extruder screw.

As a further possible way of loading the extruder screw as densely as possible with material, it is known from practice to pretreat the recyclate in a cutter compactor. The recyclate is guided in the cutter compactor in a circle and comminuted by the cutting action of the cutter compactor. It is to be observed here that the material segregates: heavier constituents are forced outward more strongly owing to the centrifugal force, whereas lighter constituents stay longer in the middle of the cutter compactor. This considerably impairs a sought-after homogeneity of the material, this homogeneity being desired later on in the extruder. This applies in particular also not just whenever the recyclate is fed to the extruder screw alone, but also when additives are added to the recyclate. Owing to the segregation and the different dwell time in the cutter extruder, the distribution of the additive in the material is also uneven. These two different reasons for inhomogeneities can be supplemented by the fact that the heat input into the material can cause the material to “crimp”. “Crimping” in this connection denotes the temperature-related deformation of the material, as for example is also to be observed when fibers or foils are held close to an open flame and thus buckle and contract. Quite apart from the fact that, owing to the modified material structure, crimping is in any case fundamentally undesirable, the loading to thermal owing the aforementioned different dwell time for different material fractions also occurs to different extents in the material, and therefore some fractions crimp and others do not, as a result of which inhomogeneities are brought about in the treated material in a third respect.

The extrusion of recyclate in many cases does not produce final products but rather a granular material, which is used similarly to the granular material made of virgin plastic in the plastics processing industry to produce the respective products. A chopper, for example a hot chopper, which divides the continuous material strand leaving the extruder can therefore be connected downstream of the extruder, as the latter is provided within the meaning of the present invention, with the result that a granular material is provided.

The invention is based on the object of improving a method of the type in question to the effect that as dense and homogeneous as possible a filling of an extruder screw with material is enabled. The invention is also based on the object of specifying an apparatus for carrying out this method.

This object is achieved by a method as claimed in claim 1 and by an apparatus as claimed in claim 8.

The invention proposes in other words to connect a press agglomerator upstream of the extruder. This press agglomerator ensures a largely uniform comminution and agglomeration even in the case of a fed mixture of different materials. Press agglomerators are known in different embodiments, e.g. in the form of a die press, extrusion press, screw press, perforated-roll press or roll press, in the form of a flat-or annular-die pelletizer. The agglomerates can leave the press agglomerator in the form of finished, separate shaped bodies, e.g. when they are pressed into the recesses of two opposite rolls of a roll press to afford these shaped bodies. As an alternative to this, it may be provided that a comminuting unit is connected downstream of the press agglomerator, e.g. when the shaped bodies created in a roll press are separated from one another only by lines of weakness but continue to adhere to one another and are separated from one another in a downstream crusher, or when they are created in the form of a continuous material strand which is divided by a downstream blade into a multiplicity of individual small bodies. Both the shaped bodies created and the individual small bodies are referred to as pellets in the context of the present proposal.

The recyclate prepared in the press agglomerator can therefore according to the proposal be fed to the extruder screw as material in granular form. While granular material frequently designates small bodies which have irregular, often random shapes or sizes, the small bodies used according to the proposal have quite uniform properties in terms of their shape or size, and therefore they are referred to as pellets in the context of the present proposal. The method according to the proposal can therefore be used, even when use is made of a recyclate, to load the extruder screw with a material which in terms of its homogeneity is nearly as advantageous and has properties approximately as uniform as is the case in other respects with virgin plastics granular material. The pellets also enable a similarly compact filling of the extruder screw to the use of virgin plastics granular material, so that air pockets during and after the extrusion can largely be avoided, and in any case can be prevented considerably more effectively than has been known to date from practice when use is made of recyclate. As dense and homogeneous a filling as possible of the extruder screw assists a continuous, maximum material throughput of the extruder and thus the economically advantageous, maximum ejection of material therefrom with as uniform and high as possible a quality.

The recyclate can for example be pelletized in a flat-die press, which makes it possible to comminute and pelletize even fibrous substances and non-melting materials. Purely by way of example for the configuration of a press agglomerator and nonlimitingly, it is therefore the case below in the description of the present proposal that the use of a pelletizer, particular a flat-die press, is mentioned.

According to the proposal, it is also provided that the pellets leaving the press agglomerator are guided on the shortest possible path and in the shortest possible time—advantageously i.e. directly—into the extruder screw with their inherent residual heat. According to the proposal, the pellets have a temperature of 50° C. or more, and since they leave the press agglomerator frequently with temperatures of approximately 100° C., the temperatures with which the pellets enter the extruder, depending on the configuration of the arrangement used, are frequently considerably higher than 50 or 60° C., for example at 80° C. or even also above 90° C.

Temporary storage of the pellets is as far as possible avoided. Accordingly, the pellets do not need to first be cooled down, involving a high energy expenditure, in order that they do not stick to one another while being temporarily stored. Similarly done away with is the energy expenditure needed to heat the pellets after the temporary storage, in order that they can be processed in the extruder in an optimally plasticized state. In order to avoid not only the temporary storage but also long transportation routes and the use of insulated vessels or the like, this method aspect can be taken into account in the configuration of the arrangement in that the pellets are guided on the shortest possible path out of the pelletizer into the extruder screw, for example by connecting the pelletizer to the extruder, either directly or by a connecting pipe, as short as possible a supply screw or the like, with the result that in any case the inlet of the extruder, e.g. its extruder screw, is connected to the outlet of the press agglomerator. Such a combination of the installation constituent parts can be referred to as “PellEx” arrangement, in order to clarify the connection of pelletizer and extruder to afford a common arrangement.

In the pelletizer, it is also possible for non-thermoplastic materials to be processed, and therefore the recyclate used for example in addition to thermoplastic materials can contain non-also thermoplastic materials, plant fibers or the like. In comparison with other comminuting installations that might be used for the comminution of the recycled material, this is advantageous insofar as for example in a cutter compactor non-thermoplastic materials, plant fibers or other non-melting materials do not soften and cannot be processed.

Additives can be added to the pelletizer, since they are distributed uniformly over the material and accordingly uniformly contained in the pellets.

In one embodiment, the pelletizer may be configured in the manner of a press agglomerator. Various models of press agglomerators are known from practice and can be used within the context of the present invention.

A hot chopper can be connected downstream of the extruder. The granular material created here enters a liquid cooling medium here, for example water, with the result that the individual granules at least on the outside are cooled down far enough that they do not stick to one another during further transportation or during storage. The cooling medium absorbs the heat from the granular material. The cooling medium can be guided through a heat exchanger, through which an air flow is blown. The accordingly heated air can be used to preheat the recyclate before the latter is added to the pelletizer, with the result that the energy needed by the pelletizer can be reduced.

Advantageously, specifically the recyclate can firstly be washed, in order to remove superficial impurities from the recyclate. Even if the recyclate, after being washed, for example in a drum or in similar devices has adherent washwater separated from it, a considerable amount of moisture in the form of a surface film adheres to the recyclate. In practice, it is therefore time and again the case that the extruder screw is fed with material which has a moisture content of more than 10%, e.g. up to 15%. Quite apart from the fact that the extruder requires a considerable energy expenditure in order to heat this amount of moisture, convert it into vapor and then discharge it from the extruder in vapor form, this vapor formation carries the risk of formation of vapor bubbles that form undesired cavities in the flow of material in the extruder and of also not being able to discharge them from the material in the negative-pressure regions possibly provided in the extruder when these bubbles specifically are too deep inside the flow of material. The use of the process heat arising in the installation, e.g. as mentioned above from the hot chopper, for predrying the material before it enters the pelletizer is therefore a considerable advantage in terms of energy for the operation of the overall installation.

The invention is explained in more detail below on the basis of the purely schematic illustration.

The drawing illustrates a perspective view of an arrangement 1 for extruding recyclate, wherein the arrangement 1 serves for producing plastics granular material. The arrangement 1 comprises an extruder 2, upstream of which is connected a pelletizer 3 in the form of a press agglomeration unit. Furthermore, a melt filter, in the illustrated exemplary embodiment in the form of a piston melt filter 4, and a water ring granulator 5 are connected downstream of the pelletizer 3.

Recyclate, which can contain fractions of thermoplastic material, fractions of thermosetting plastic or else fibrous fractions, e.g. in the form of plant fibers, is added to the pelletizer 3 through an inlet opening 6. The recyclate has been cleaned beforehand, e.g. dry in a friction washer or wet using water. In the case of a wet wash, the washed recyclate has been predried, and therefore it enters the pelletizer 3 with as low as possible a moisture content.

In the illustrated exemplary embodiment, the pelletizer 3 is in the form of a pelletizing press, with a pan grinder, which has 3 runners 7 and a main drive 8. A die 9, on which the runners 7 run, is height-adjustably mounted, so that the gap between the runners 7 and the die 9 can be set in a manner adapted to the recyclate respectively used and the desired properties of the pellets produced in the pelletizer 3. The die 9 has a multiplicity of apertures in the form of bores, through which the recyclate passes, with the result that a multiplicity of material strands is created. An auxiliary drive 10 on the pelletizer 3 serves to drive a chopping device 11, which for example has one or more chopping blades around the periphery, such that the rotational speed of the chopping device 11 can be used to set the length of the resulting pellets.

Created by the chopping device 11 from the material strands downwardly leaving the die 9 is a multiplicity of pellets, which fall downward out of the pelletizer 3 through a transfer shaft 12. Through the transfer shaft 12, the pellets enter the extruder 2 on the shortest possible path, without long transportation routes, temporary storage or the like. In the transfer shaft 12, the arrangement 1 may have a dust separator, which serves to separate from the pellets the material dust fraction that could not be bound in the pellets. The separated dust can be guided to the inlet opening 6 and thus reintroduced into the pelletizing process.

As a departure from the exemplary embodiment illustrated, the pellets can enter the extruder 2 directly through a differently configured, shorter transfer shaft 12. In the exemplary embodiment illustrated, however, the addition of additives to the pellets is provided, with the result that these additives are then, in the extruder or on the way thereto, e.g. in a feed screw, mixed with the pellets. The additives may for example be dye pigments or reinforcing materials or fillers, such as talcum, or the like. The additives may be present in powdered, pulverulent, granular or liquid form or likewise in pellet form. The additives are then supplied into the flow of pellets in the intake zone of the extruder 2. It may be provided to use one or more additional press agglomerators, such as pelletizers, which can make poorly meterable additives meterable, and able to be taken in by the extruder 2, through compaction.

The transfer shaft 12 therefore extends such that two volumetric or gravimetric metering stations 14 that serve to introduce the additives into the flow of pellets are connected to it. The pellets enriched with the additives enter, through the transfer shaft 12, an extruder screw of the extruder 2, which is driven by a drive motor 15, wherein an extruder transmission, not visible in the drawing, is arranged downstream of the drive motor 15 in a housing 16 of the extruder 2. The housing, surrounding the extruder screw, of the extruder 2 can have ribs extending on the inside in the longitudinal direction, in order to prevent the material moved by the extruder screw from rotating together with the extruder screw, as this would adversely affect the conveying action of the extruder screw.

The pellets fall with a temperature of approximately 80 to 100° C. through the transfer shaft 12 and therefore enter the extrusion process directly with their inherent residual heat. At its lower end, the transfer shaft 12 is connected to the intake port of the extruder 2, in particular its extruder screw, it being possible for a single-screw, twin-screw or multi-screw extruder to be involved.

The extruder 2 has within its housing 16 a negative-pressure degassing installation 17, which serves to separate volatile substances from the melt. In the piston melt filter 4, which is connected downstream of the extruder 2, contaminants and dirt particles are removed from the extruded material strand. Then, the extruded and cleaned material strand is granulated in a hot chopper, which in the exemplary embodiment illustrated is in the form of the water ring granulator 5. In the process, there is an intensive transfer of heat from the granules, the heat of which is extracted, to the water, with the result that the surface temperature of the granules is reduced far enough for them to then not stick to one another.

The water heated in this way is used to predry the washed recyclate: for example, the latter can be cooled in a water/air heat exchanger, and the heated air is blown onto the washed recyclate, before the latter enters the pelletizer 3. Or, in a heat exchanger the heated water can give up its heat to a medium serving to heat elements that for their part bring about the predrying of the washed recyclate through radiant heat. Or the heated water can itself, without a heat exchanger, serve to heat the mentioned elements, which bring about the predrying of the washed recyclate through radiant heat.

### List of Reference Signs

1 Arrangement
2 Extruder
3 Pelletizer
4 Piston melt filter
5 Water ring granulator
6 Inlet opening
7 Runner
8 Main drive
9 Die
10 Auxiliary drive
11 Chopping device
12 Transfer shaft
14 Metering station
15 Drive motor
16 Housing
17 Negative-pressure degassing installation

1. A method for extruding recyclate,
wherein the recyclate contains light substances and/or fibers, and wherein the recyclate firstly is comminuted and compacted
and in a later method step is guided into an extruder (2),
characterized
in that the recyclate is agglomerated in a press agglomerator and in the process is heated,
and is subdivided into pellets,
and in the still-warm state, with a heat that remains from the agglomeration within the material of at least 50° C., is guided into the extruder (2).

2. The method as claimed in claim 1,
characterized
in that the recyclate is pelletized by comminuting and through-mixing it in a pan grinder.

3. The method as claimed in claim 1,
characterized
in that the recyclate is pelletized in a flat-die press.

4. The method as claimed in claim 1,
characterized
in that the pellets created are guided directly from the press agglomerator into the extruder (2).

5. The method as claimed in claim 1,
characterized
in that the recyclate is washed before it is guided into the press agglomerator.

6. The method as claimed in claim 1,
characterized
in that the heat given off from the extruded material is used by means of a heat exchanger as process heat or as a space heater.

7. The method as claimed in claims 5,
characterized
in that the heat given off from the extruded material is used by means of a heat exchanger as process heat in order to heat air,
and in that the heated air is used to dry the washed recyclate.

8. An arrangement (1) for carrying out the method as claimed in claim 1,
comprising an extruder (2), which has an inlet for the material to be extruded,
and comprising a press agglomerator, which has an inlet opening (6) for recyclate to be agglomerated and an outlet for the pellets created,
wherein the press agglomerator is arranged connected upstream of the extruder (2) such that the inlet of the extruder (2) is connected to the outlet of the press agglomerator.

9. The arrangement as claimed in claim 8,
characterized
in that the press agglomerator is configured as a pelletizer (3) in the form of a flat-die press and is arranged over the inlet of the extruder (2).

10. The arrangement as claimed in claim 8,
characterized
in that a filtering device is connected downstream of the extruder (2) and is intended to filter contaminant and dirt particles out of the extruded material.

11. The arrangement as claimed in one of claims 8,
characterized
in that a chopper is connected downstream of the extruder (2) and is intended to granulate the extruded material.

12. The arrangement as claimed in claim 11,
characterized
in that the chopper is in the form of a water ring granulator (5).

13. The arrangement as claimed in claim 11,
characterized
in that the chopper is operatively connected to a heat exchanger such that heat is transferred to an air flow,
and in that a fan arrangement is configured such that it guides the heated air flow onto the recyclate, before the latter enters the inlet opening (6) of the pelletizer (3).
